(19) United States
(12) Patent Application Publication
(10) Pub. No.: US 2004/0052342 A1
(43) Pub. Date: Mar. 18, 2004

(54) Method and communication system for generating response messages

(76) Inventors: Wolfgang Jugovec, (US); Shaun Baker, (US); Markus Von Arx, (US); Marcel Henggeler, (US); Matthias Giger, (US)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/656,106

(22) Filed: Sep. 8, 2003

Related U.S. Application Data
(63) Continuation of application No. PCT/EP02/00742, filed on Jan. 25, 2002.

(30) Foreign Application Priority Data
Mar. 13, 2001 (EP) 01 106 128.0

(51) Int. Cl. H04M 1/64

(52) U.S. Cl. 379/88.22; 379/88.25

(57) ABSTRACT

The present invention relates to a method and to a communication system for generating a response message to incoming messages. The system includes an interactive machine, a switchboard unit, a voice input module and a voice output module. The incoming messages are configured as real-time calls, as stored calls or as text messages. A standardized address is established for these messages and is fed to a voice input module. An inquiry directed to a database is established via process steps in an acoustic preprocessing unit, a speech recognition unit and a text output dispatcher. Response messages from the database are transferred to the origin of the incoming message either directly or via a text preprocessing unit, a speech synthesis unit and a voice output dispatcher. Calls that cannot be processed are switched to an agent. The modular design of the communication system allows for the use of different products of speech synthesis or speech recognition without new integration.

### CROSS REFERENCE TO RELATED APPLICATIONS

The present application is a continuation of International Application PCT/EP02/00742, which designated the United States and was filed on Jan. 25, 2002, and further claims priority to European patent application number 01106128.0, filed 13 March, 2001, both of which are herein incorporated by reference.

### BACKGROUND OF THE INVENTION

The present invention relates to a method for generating response messages to incoming messages using a communication system and a communication system for generating response messages to incoming messages.

The concept of speech processing encompasses a conversion from speech to text on the one hand—usually referred to as speech recognition—and a conversion from text to speech—usually referred to as speech synthesis—on the other hand.

So-called “software development kits” are available for the conversion from text to speech and vice versa, with which products are integrated into corresponding customer solutions from case to case and on an individual basis. The disadvantage is that a switch to a different product requires a completely new integration process.

Inquiries from customers should as far as possible be independent of the type of medium used for the inquiry. The following types of inquiry/response medium are frequently encountered:

direct telephone conversation with an agent;

a voice recording device—also referred to as a telephone answering machine—which is dialed directly or switched in when no agent is available;

email containing an inquiry in text form; and

email containing an audio file with a spoken message.

Furthermore, it should be irrelevant as to whether an email in text form originated in such a form or was generated, for example, from the GSM Short Message Service.

WO 99/07118 describes a communication system which allows a time management system to be synchronized with spoken messages contained in emails with regard to appointment data such as date/time, location and, should the need arise, subject, or to be interrogated, and an email to be generated automatically containing the originally agreed or the new appointment data.

In the case of communication systems of the aforementioned type as also, for example, in the case of speech synthesis for information systems, the problem exists when switching to a different speech synthesis product (TTS Text to Speech) and/or a different speech recognition product (ASR Automated Speech Recognition) whereby a completely new process is required in order to effect integration into the communication and database system in question.

### SUMMARY OF THE INVENTION

An object of the present invention is therefore to set down a method and a communication system of the type described at the beginning which allows an automated generation of response messages and can be adapted to different speech synthesis and/or speech recognition products with a low integration resource requirement.

According to the present method, incoming calls, regardless of their type, are automatically analyzed. Calls which can be converted into inquiries directed to a database result in a response message generated by a database. The response is conveyed directly as a text response message or as a result of a conversion in a voice output module as a spoken response message to the origin. Those calls which cannot be converted are assigned to an agent for further handling on a personal basis.

The present invention also includes a communication system. The communication system is organized into functional units such that products can be used for the different units which can be easily exchanged and which allow distribution to different servers in a computer system.

This can therefore yield following additional advantages:

i) As a result of the fact that the response messages converted by the voice output module are supplemented by fixed speech texts, a person making an inquiry has the resulting impression of a personal response and this helps to dispel prejudices and any aversion with regard to automated information systems.

ii) As a result of the fact that the text message stored together with the standardized address is supplemented prior to execution with a comment text which is dependent on the result of the conversion, all incoming text messages are responded to in a form which is also acceptable to less able users.

iii) As a result of the fact that, prior to conversion, in the voice output module the response message is grouped in a text preprocessing unit contained in the voice output module in respect of the digits contained in the response message or is supplemented phonetically in respect of foreign language words contained in the response message, the generated response message can be easily adapted to the different habits in the language regions or countries, and therefore enhances the acceptance in the usage of such communication systems to a wider audience.

iv) As a result of the fact that the implementation of the switchboard unit and/or the voice input module and/or the voice output module is distributed over a plurality of servers connected by way of a network, the communication system according to the invention can be implemented in a form adapted to the respective application and scaleable to the respective server environment.

v) As a result of the fact that the interfaces with the speech synthesis unit or with the speech recognition unit are designed such that on the different servers different speech synthesis units or different speech recognition units can be exchanged with one another on the servers, different products can be used in parallel without requiring a new integration process and as a result of the parallel use of different products specific product characteristics can be put to special use or avoided.

vi) As a result of the fact that on the basis of an item of information contained in the stored incoming message, inquiries are directed by way of an external interface to an external database in method steps B1 and that corresponding responses are conveyed to the database and stored there, a person can subscribe to a service without the identity of that person needing to be divulged during interrogation of the external database.

The present invention further comprises a method for generating response messages to incoming messages by means of a communication system which can be coupled with at least one database, said communication system comprising a switchboard unit, at least one voice input module, and at least one voice output module, said messages comprise one of spoken telephone calls and text messages, and terminals for agents are assigned to said communication system, comprising the steps of:

analyzing types and sources of messages incoming to said switchboard unit;

linking a type and a source with a respective message,

storing said respective message, said type and said source in a first storage area as a standardized address;

converting text messages or calls incoming to said at least one voice input module and processed by said voice input module into queries;

conveying said queries to said at least one database; generating response messages via said at least one database;

storing said response messages in a second storage area;

assigning to an agent calls which are not processed or which can not be processed by said voice input module; and

sending said response messages to respective sources, said response messages comprising one of text and audio format, said audio format created by conversion of a response message in said at least one voice output module.

In addition, the present invention comprises A communication system for generating response messages, comprising:

at least one voice input module;

at least one voice output module;

a switchboard unit operable with messages, said messages comprising one of telephone calls and text messages;

at least one database assigned to said communication system;

terminals for agents;

means for storing messages in a first storage area, said messages being incoming by way of said switchboard unit;

means for switching said incoming messages to one of said at least one voice input module;

means for conveying inquiries generated by the voice input module to said at least one assigned database;

means for storing response messages generated by said at least one assigned database in text form and in a second storage area;

means for assigning messages unprocessed or incapable of processing by said at least one voice input unit to an agent; and

means for conveying a response message stored in the second storage area directly or by way of a response message converted in said at least one voice output module to a source of said incoming message.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawings, wherein:

FIG. 1 depicts a structure of a communication system according to the invention set down in functional units;

FIG. 2 depicts an implementation of the method according to the invention on a computer system; and

FIG. 3 depicts the incorporation of an additional service ‘automatic notification’.

### DETAILED DESCRIPTION OF THE INVENTION

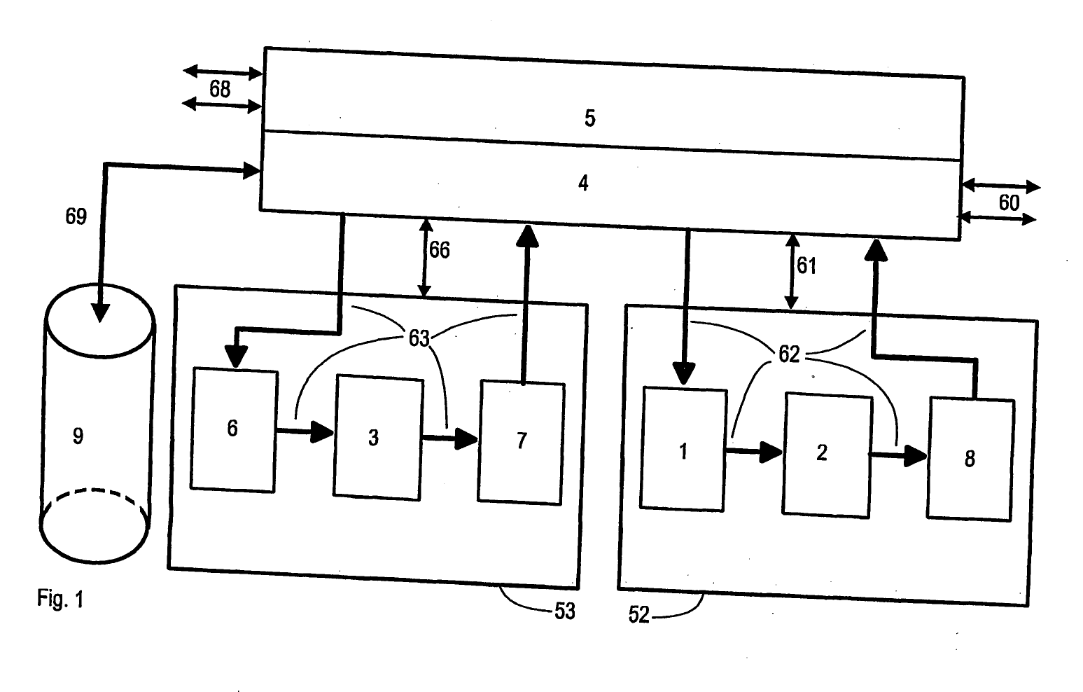

FIG. 1 depicts a structure of an exemplary embodiment of a communication system according to the invention set down in functional units. The specified paths should not necessarily be regarded as physical connections or links but should preferably be viewed as logical or functional paths. The communication system represented in FIG. 1 firstly contains the functional units interactive machine 5 and switchboard unit 4 which is attached by way of external interfaces 60 to a public or private network. Interfaces 60 can be designed for connectionless use with a packet-switched network, based on the TCP/IP protocol for example, and/or for connection-oriented use with a TDM network (Time Division Multiplex), for example using at least one ISDN S₂ primary connection. Secondly, the communication system contains a voice input module 53 and a voice output module 52. Assigned to the communication system by way of a further interface 69 is a database 9 which contains a knowledge or information base, such as for example:

a directory of people,

proposed solutions to questions posed concerning a product, and/or

information relating to the status of the elements of a power distribution network.

The interactive machine 5 is connected to terminals by way of interfaces 68. Workstation systems taking the form of personal computers and also having facilities for voice input/voice output, such as a headset/microphone assembly for example, in addition to keyboard and screen are preferably provided as terminals. Physically, the interface 68 is preferably implemented as a LAN local network (LAN Local Area Network). The switchboard unit 4 can be assigned a web server which contains that content and control information which is required by the interactive machine 5 in the interaction with the agents or with users communicating by way of the interface 60. It is also possible for the user terminals themselves to be connected to the LAN 68. Likewise, it is also possible to implement the web server as part of the switchboard unit 4.

The method according to the invention will be described on the basis of two formats for incoming messages:

Format I:

An incoming message taking the form of a telephone call independently results in a response message being generated; and

Format II:

An incoming message taking the form of a text independently results in a response message being generated.

Format I:

Prerequisite: All agents are busy or incoming calls are constantly being routed to the interactive machine 5.

I. Method step Al:

Calls incoming to the switchboard unit 4 by way of the interface 60 are received by the interactive machine 5 with an appropriate spoken comment. In this situation, these comment texts are stored as directly addressable audio files, preferably in the voice output module 52. In an interactive session controlled or to be controlled by the interactive machine 5 and/or by the calling person the call is analyzed in respect of its type, source and source address, and placed together with the spoken call text in a first storage area as a standardized address TYPE_ADDR.

Such an address TYPE_ADDR is thus created for each call. The following Table 1 gives an example of a structure for a standardized address TYPE_ADDR.

Structure of a standardized address TYPE_ADDR

TABLE 1

| Field | Meaning |
|---|---|
| DATE_TIME_MSG | Date/time of arrival |
| ADDR_SRC_TYPE | Type of incoming message |
| ADDR_SRC | Source address |
| ADDR_SRC_CODING | Coding |
| ADDR_SRC_PATH | Path of source |
| DATE_TIME_ANSWER | Desired date/time of response |
| | message |
| INPUT_ADDRESS | Recipient address |
| : | |
| ADDR_SRC_MSG_TYPE | File format of incoming |
| | message |
| PTR_ADDR_SRC_MSG_BODY | Pointer to stored incoming |
| | message |
| ANSWER_TYPE | Type of generated response |
| | message |
| : | |
| PTR_ANSWER_FILE | Pointer to the response file |
| STATUS | Status of incoming message |
| : | |

With regard to the source address ADDR_SRC, either the email address noted as Sender, for example in the case of a pure IP voice transmission or the subscriber number according to the ISDN CLIP feature (Calling Line Identification Presentation) is stored in the standardized address TYPE_ADDR. The incoming path is entered for the source ADDR_SRC_PATH, which is relevant to the subsequent signal processing in the acoustic preprocessing unit 6. The incoming spoken message text, in other words a telephone call, is preferably stored as an audio file on a mass storage facility which is referred to in the following as the second storage area (not shown in FIG. 1). If the incoming telephone call has been received as a file containing the verbal message from a person, the file can be stored directly in the received format, for example .wav or mp3. A pointer is preferably provided for linking the standardized address TYPE_ADDR with the message. The linkage can be provided on two sides, in other words, a pointer to the standardized address TYPE_ADDR is also stored in addition to the saved file.

I. Method step B1:

The further processing of the incoming telephone call takes place in a voice input module 53 which includes the previously mentioned acoustic preprocessing unit 6, a speech recognition unit 3, and text output dispatcher 7. The information or data flow is generally referred to in the voice input module 53 by the reference character 63; concrete reference is made in each case in the following descriptions to the respective interface or the respective format between the individual units. In the first instance, the stored telephone call is delivered to the acoustic preprocessing unit 6. On the basis of the entries in the fields ADDR_SRC_CODING, ADDR_SRC_PATH und ADDR_SRC_MSG_TYPE, a correction of a systematic acoustic deviation from a standard level or a noise suppression for example, can be performed in the acoustic preprocessing unit 6; by preference, a conversion to a uniform file format is also performed in the acoustic preprocessing unit 6. Following this preprocessing, the incoming telephone call is delivered to the speech recognition unit 3 and the latter generates a text file which contains the content of the spoken message in the form of text. This text file is then delivered to a text output dispatcher 7 in which a semantic analysis is carried out. If this semantic analysis results in a plausible context relating to the intended query in the database 9, a query file QUERY_FILE is created in accordance with a defined syntax. Table 2 gives an example of the structure for such a query file QUERY_FILE.

QUERY_FILE

TABLE 2

| Name | Meaning |
|---|---|
| QUERY | Query identifier |
| SUBSCRIBER_ID= | Subscriber number |
| NAME= | Name |
| LOCATION= | Location |
| POSTAL_CODE= | Postal code/zip code |
| : | |

It is assumed with regard to this example that a calling person is requesting information about a telephone number for a subscriber who is identified by way of his name and place of residence. Further fields which are not shown can be provided for the query in the query file QUERY_STRUCTURE. By means of a command COMMAND delivered by way of the control interface 66 to the switchboard unit 4, the query file QUERY_FILE is conveyed to a database 9. The response message generated by the database 9 is preferably stored as a structured file by the switchboard unit 4 in a second storage area and the corresponding standardized address is linked to this response file, to which end a field PTR_ANSWER_FILE is provided in the standardized address. A field INPUT_ADDRESS contained in the standardized address can be used for the aforementioned semantic analysis, from which field the rule can be derived as to which type of response messages the calling person requires. This is important particularly when totally different categories of incoming messages and corresponding response messages are to be generated using the communication system according to the invention, for example address information for the general public and network status information for a narrowly delimited customer base for a network operator.

I. Method step C1:

For the case where the speech recognition unit 3 is unable to convert the incoming call into a text file, a corresponding command COMMAND is conveyed by way of the control interface 66 to the switchboard unit 4 which forwards the incoming call to an agent, for example in the form of an email. On the one hand, this email contains the standardized address and on the other hand the call, for example in the form of a so-called attachment in .wav format. Compared with the stored standardized address, the entry of the standardized address in this email can only contain those fields which are required for handling by an agent, whereby the content is preferably converted into a user-friendly format for display purposes. The delivery to an agent does not need to be done on a personalized basis, rather a single inbound mailbox can be provided for all agents which will be processed sequentially by the agents. If no such query file can be created by the text output dispatcher, a corresponding command COMMAND is conveyed by way of the control interface 66 to the switchboard unit 4 and the incoming call is forwarded as previously described above using an email to an agent. The aforementioned delivery and also the forwarding of calls take place independently in the interactive machine 5.

I. Method step D1

On the basis of the status information STATUS and an entry in the field ANSWER_TYPE of the standardized address, the response message stored in the second storage area in text form is delivered to the text preprocessing unit 1 contained in the voice output module 52. The information or data flow is generally referred to in the voice output module 52 by the reference character 62; concrete reference is made in each case in the following descriptions to the respective interface or the respective format. Depending on the application, a plurality of possibly cumulative steps is to be applied in the text preprocessing unit 1 to the response message present in text form. In the first instance, possible included abbreviations such as “str.” in “Albisriederstr.” for “strasse” or NE in “Fleurier NE” for “Neuchâtel” are expanded as text. In a further step, the text file is adapted to the habits of the respective diction by the text preprocessing unit 1 with the aid of a phonetic or a syntactical lexicon. Telephone numbers such as “0714953286” are not spoken as one number but rather as a string of numbers; consequently the aforementioned number is divided into the number string “0 71 495 32 86”. Specifically in countries having several official languages, certain address components can be stored in different languages, for example “Dufourstrasse” or “Mythenquai”. The correct written entry “Dufour” is converted into a phonetic entry “düfuhr”. The aforementioned lexicons can be assigned as a further database to the voice output module 52 or be contained in the voice output module 52. A further method step undertaken in the text preprocessing unit 1 is the conversion of words into so-called “phonemes” or sounds; depending on the product used, this method step can also be handled in the speech synthesis unit 2. The response file converted into a phonetic text file is delivered to the speech synthesis unit 2 which creates a voice output file containing the spoken response message. This voice output file is preferably in .mp3 format and is delivered to the voice output dispatcher 8. The voice output dispatcher 8 supplements the aforementioned voice output file with so-called “voice prompts” which are spoken text modules used in order to convey the information to the caller in a form consistent with good practice. Examples of such text modules include: “The address you require is:” or “Thank you for calling”. A corresponding command COMMAND is conveyed to the switchboard unit 4 by way of the control interface 61, which command reports the successful generation of a voice output file. This voice output file is preferably likewise stored in the second storage area. In this situation, a pointer to the voice output file is set in the standardized address and the status is tracked, for example READY_FOR_DISPATCHING. Depending on the entries in the standardized address, the response file is returned as an email to the source address or played back to the source address following a successful connection establishment (CONNECT).

As a result of the entries in the standardized address, in particular those in the Status field, it is also possible to respond to an incoming call in real time using the method steps previously described. In this situation, immediately prior to method step B1 an iteration of method steps for voice recognition and for voice synthesis takes place in accordance with the interactive session to be conducted. This iteration continues to be performed until the single inquiry can be formed by the speech recognition unit 3 and the text output dispatcher.

Format II:

Prerequisite: An incoming message taking the form of a text.

An incoming message in the form of a text preferably has an agreed format which is either created in such a way by an application being run by the inquirer or is created directly in that form by the inquirer. In this situation, a format is advantageously agreed which comprises a structure in accordance with the representation in Table 2. In this situation, additional fields can be provided in which can be entered for example the desired response type or the desired time of response. The entry for the time of response is advantageous for the generation of an additional service in which for example a mobile subscriber can receive certain information which is dependent on the time of inquiry in the database while his journey is in progress, for example status data relating to a network. An embodiment of the present invention provided cumulatively under “Format I” is described below.

II. Method step Al

The method step Al does not differ from that in which a telephone call is treated as an incoming message. To add to the method step A1 described under I., in a preferred embodiment the entries made in a standardized address can be used for controlling the entire method execution. By means of the fields ADDR_SRC_TYPE, ADDR_SRC, DATE_TIME_ANSWER, ANSWER_TYPE and the updating of the handling status of an incoming message in the STATUS field by way of the control interfaces 61 and 66, such a message can be assigned directly to a unit in the two modules 53 and 52 or to the database 9. Alternatively, it is also possible without affecting the specified information flow, on the basis of the entries in the fields in the standardized address, to forward files transparently from the individual units, in other words without the execution of a processing step.

II. Method step B11

As explained above, the incoming message is delivered to the text output dispatcher 7 in which the creation of a query file QUERY_FILE described under B1 is performed. In this situation, the aforementioned semantic analysis can also be dispensed with since, in particular, no filler words are to be expected in an incoming message in text form. Nevertheless, the situation whereby the text output dispatcher 7 is unable to create a query file must be covered. If this situation occurs, a corresponding command COMMAND is conveyed to the switchboard unit 4 by way of the control interface 66 and the message in question is either returned to the source address provided with an elucidated text or is assigned to an agent in the form of an email. For the normal case where a query file QUERY_FILE can be successfully created, the further processing takes place in accordance with the method steps C1 and D1 described above.

The method steps described above in the voice input module 53 and in the voice output module 52 are independent of one another according to the respective application and to the respective source of the messages and can thus be freely combined. In particular, the further processing of the response message generated by the speech synthesis unit is also independent of the acoustic preprocessing, for example.

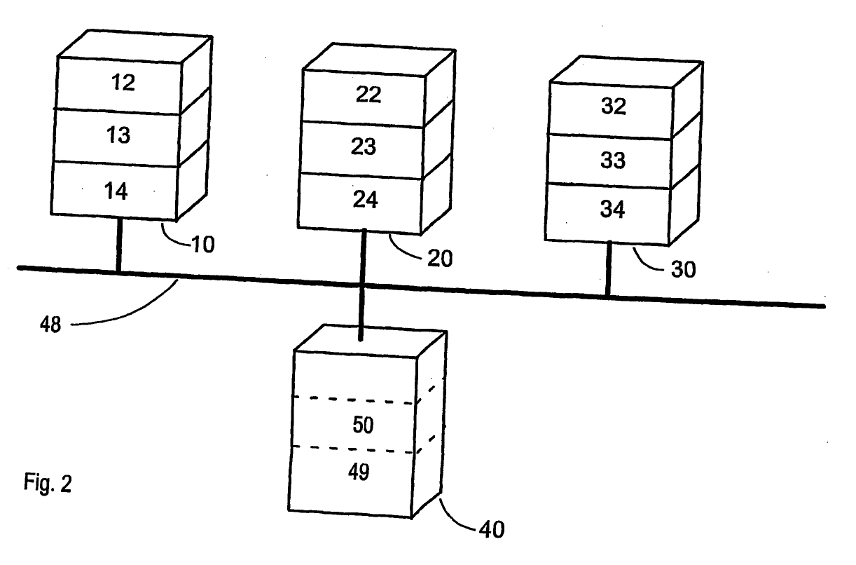

FIG. 2 shows a preferred implementation of the method according to the invention on a computer system. The reference characters 10, 20, 30 and 40 serve to represent four servers which each comprise a processor system and a mass storage facility. These servers are interconnected by means of a local network 48. The terminals provided for the agents are connected to this network 48 directly or by way of routers, for example. Gateways or a private exchange can be provided for linking to the outside world, whereby the conversion of an incoming call from the public circuit-switched network into a packet-oriented format, based on the Internet Protocol for example, may occur. This local network can be connected directly to an Internet service provider (ISP) by way of further routers and, if need be, a firewall. The conversions to be performed in the speech synthesis unit 2 and the speech recognition unit 3 in accordance with method steps B1 and D1 require a high level of computing power. In an implementation according to FIG. 2 the aforementioned units 2 and 3 are distributed over the servers 10, 20 and 30, in other words one complete implementation in each case, as represented by the reference characters 12, 13; 22, 23 and 32, 33. This has the result of permitting a parallel mode of operation which significantly increases the processing capacity and also the redundancy of the method according to the invention. Similarly, the switchboard unit 4 is a threefold implementation. In this embodiment the interactive machine 5 is assigned to the fourth server 40. The load distribution for the aforementioned three servers is also undertaken on the server 5. In this implementation, the database 9 is contained on the fourth server 40. Depending on the application, the database can also be located remotely or be operated by an external provider. The special lexicons contained in at least one further database, which are required by the text output dispatcher 7, are preferably implemented once on one server. The assignment to the individual servers of the other units such as the acoustic preprocessing unit 6 or the text preprocessing unit 1, for example, is not shown in FIG. 2. A “distributed” assignment or an assignment to a single server are similarly possible.

An architecture in accordance with CORBA is preferably used in order to implement the individual units. The acronym CORBA stands for Common Object Request Broker Architecture. The technical implementation of this architecture is based on so-called ORBs (ORB; Object Request Broker). An ORB enables a client—that is an incoming message in this case, for example—to send a command COMMAND (cf. for example in the case of method steps B1, D1) to a server object which can be running on the same or a different server. The ORB is the entity which finds the server object, passes the parameters, invokes the function there and returns the result to the client after processing has been completed. The CORBA architecture contains an implementation-independent interface description language IDL. Once the interface definition has been made, different languages can then be used in the coding of client and server object, for example Java for the client, C++ for the server object, as well as a database query language for accessing the database 9 or the database containing the special lexicons. Thanks to the use of the CORBA architecture and to the subdivision into functional units, it is possible in particular for the speech recognition unit 3 and for the speech synthesis unit 2 to use products from other manufacturers without requiring a new integration of the entire communication system. As an alternative to the CORBA architecture, the object-oriented programming language Java can also be used for the implementation on the different servers. The interfaces 62 with the speech synthesis unit 2 can be implemented in the case of CORBA by means of SAPI (Speech Application Programming Interface) or, if the aforementioned programming language Java is chosen, by means of JSAPI (Java Speech Application Programming Interface). Both Java and JSAPI are characterized by the fact that the source program code translated following a compilation into so-called “byte code”—including the interface definitions—can run on any server in the computer system; the only prerequisite is that a corresponding runtime system, which in this case is a so-called “Java virtual machine”, is installed that translates the “byte code” into machine instructions capable of running on the server in question. The language JSML (Java Speech Markup Language) is used in preference to the language JSAPI for the method steps D1 explained above in the description for Format I. To this end, a “SAYAS” element is used which enables a prosody analysis and a prosodic marking of the phrases and phrase portions present in text form to be performed. It is thus also possible to mark the beginning and end of a clause or segment in the phrases to be synthesized in order thereby to increase the intelligibility for the listener through the intonation of the synthetic voice. The aforementioned expansion of abbreviations can similarly be performed using the SAYAS element of JSML, whereby application-specific abbreviations are preferably expanded beforehand by means of normal text substitution.

The concrete implementation is based for example on a supply package which offers a “createsynthesizer” method in a “javax.speech” class. The required resources, such as priority and storage space for example, are made available by means of the “Allocate” method and switched to an active state by means of the “Resume” method. The “Generate” method synthesizes a voice message from a character string, prosodically supplemented as previously mentioned, for example in an .mp3 or .wav file format. The “Deallocate” method serves to once again release the resources made available. This program flow represented as being sequential can run in a plurality of parallel instances, in time, in this situation, in order to allow support for different callers at the same time. A required high level of parallel operation is preferably achieved by means of an implementation which corresponds to the structure of a computer system illustrated in FIG. 2.

The use of Java has the advantage that both for the interactive machine 5 and also for the interfacing with the speech synthesis unit 2 the programming language is homogeneous insofar as this simplifies the development.

As a result of the distribution of the functional units over the different servers 10, 20, 30 and 40 it is also possible to use different products at the same time. For example different speech synthesis products for the speech synthesis unit 2/12, 22, . . . or different speech recognition products for the speech recognition unit 3/13, 23, . . . in accordance with the illustration in FIG. 2 may be used. As a result, these units 12, 22, . . . or 13, 23, . . . are interchangeable amongst one another, such that a switch of product can take place without a new integration whilst retaining the interfaces in the different views 61, 62 or 63, 66 of the communication system according to the invention (also referred to as IVR system).

In a further embodiment of the present invention, provision can be made whereby a caller can define a so-called alarm window with an incoming message. For example, a threshold can be defined for the status of a network element. If a threshold defined by the caller is exceeded, for example a certain number of alarms or alarms above a certain priority, a response message is sent by the communication system according to the invention to the aforementioned caller; for example “The network element Wülflingen 3 has 4 alarms of level 2 and higher”. The medium for this response message can take the form of a text message using the SMS service (Short Message Service) on a GSM terminal or the form of a call whose synthetic voice has been created in the speech synthesis unit 2. The threshold value mentioned above can also be applied to non-technical applications, for example a particular market value for a share.

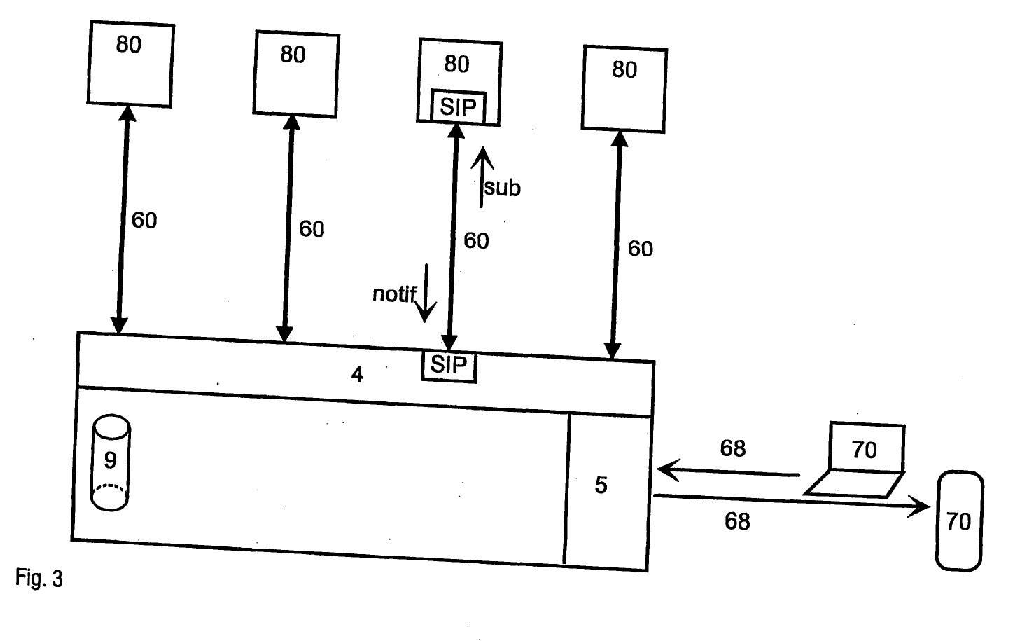

In the following, an advantageous further embodiment of the aforementioned alarm windows is described as a subscribeable service with reference to FIG. 3. A multimedia communication system in the embodiment according to FIG. 1 is represented in a greatly summarized form in FIG. 3. The switchboard unit 4 can be connected to service providers 80 by way of the aforementioned interfaces 60 in this further embodiment by using the TCP/IP protocol. In this situation, the interface does not need to be implemented separately for each service provider but can for example be routed to an Internet service provider, whence the other service providers and/or content providers can be addressed. In this embodiment, services implemented in a multimedia communication system can be subscribed to as follows. A message having the following contents (shown here in text form) can be sent from a terminal 70 connected by way of the interface 68 to the communication system:

Service=AIR_TICKET_OFFER;

Origin=ZURICH;

Destination=NICE;

Date/Time (earliest)=30-01-2002/;

Date/Time (latest)=01-02-2002/;

Price (max) in CHF=800;

Category=ECONOMY.

The service providers represented in FIG. 3 by the reference character 80 represent airline companies in this example which make their offers available by way of a web interface, for example. The implication of the reference character 80 in accordance with FIG. 3 is that from the technical viewpoint the offer data is maintained on at least one database or on a database system and can be queried from external locations, using the Internet as a transport medium for example. The aforementioned service of the multimedia communication system creates inquiries of a certain periodicity made to the aforementioned service providers 80; the responses are received as messages in Format II (cf. description above) by the communication system and are stored as standardized addresses. In this situation, a comparison is additionally performed in method step B1 with the threshold value specified by the subscribing person. Only when the current value for the threshold is undershot is a response message generated in this method step B1, which is placed in the second storage area. In method step Dl, a response message is sent in the form of a text or voice message to the address assigned to the person in question. In this situation, such an address can also serve to include a presence application in which the actual accessibility of the person in question is stored, with the result that the response message is sent in that medium which is compatible with the type of the device that this person is able to use at the time in question. In the terminology of such services the sending of a response message—in whichever format—is referred to as a notification.

The SIP protocol is advantageously employed in particular in order to implement such a service with an assigned presence application. In this situation, provision can also be made on the part of the service providers to likewise handle an inquiry and response by way of a message exchange based on the SIP protocol. An example of such a sequence is given in the following, whereby the reference characters “sub” and “notif” represent the message direction in FIG. 3.

SUBSCRIBE sip: sipuaconfig@config.localdomain.com SIP/2.0

To: sip:sipuaconfig@config.localdomain.com

From: sip:10.1.1.123;Vendor=acme;Model=nodel-a;Version=1.5.0.1;Serial=1234567890;Mac=000aaa1234cd

Ca11-Id: 987654321@10.1.1.123

Cseq: 1 SUBSCRIBE

Event: Sip-Device

Config-Allow: tftp, http, https

Expires: 86400

Content-Length: 0

NOTIFY sip:10.1.1.123 SIP/2.0

To: sip:10.1.1.123;Vendor=acme;Model=model-a;Version=1.5.0.1;Serial=1234567890;Mac=000aaa1234cd

From: sip:config.localdomain.com

Call-Id: 987654321@10.1.1.123

Cseq: 22 NOTIFY

Event: Sip-Device

Content-Type: text/plain

Content-Length: 79

Sip-Device:

Sequence=1;Url=http://config.localdomain.com/device/1237890

This embodiment of the present invention is not restricted to enabling the subscription to such a service only from a single terminal 70 but can be implemented by means of any message incoming by way of the interfaces 60 and 68. A particular advantage of this implementation is the fact that the respective persons remain anonymous as a result of the inquiry to the service providers. The communication system according to the invention thereby fulfills a so-called trust center function. A further advantage of the proposed implementation of such services also lies in the fact that no software adaptations whatsoever are required on the part of the service providers or content providers 80 in respect of their available databases and servers. Furthermore, a certain convergence of notification is achieved insofar as the person using a service of this type does not need to concern himself with the actual providers.

The AIR_TICKET_OFFER service described above simply constitutes one example. Further examples of possible forms of such services follow:

i) electronic lost-and-found office whereby objects can be reported as lost and, when any such object is handed in, a notification is sent to the person or persons who have reported an object of the type in question;

ii) notification relating to the dispatch of a postal shipment,

iii) notification relating to apartment rental offers whereby the person subscribing to this service can specify the size, the accommodation, a price category and also the timing of the availability of the apartment.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

We claim:

1. A method for generating response messages to incoming messages by means of a communication system which can be coupled with at least one database, said communication system comprising a switchboard unit, at least one voice input module, and at least one voice output module, said messages comprise one of spoken telephone calls and text messages, and terminals for agents are assigned to said communication system, comprising the steps of:
analyzing types and sources of messages incoming to said switchboard unit;
linking a type and a source with a respective message,
storing said respective message, said type and said source in a first storage area as a standardized address;
converting text messages or calls incoming to said at least one voice input module and processed by said voice input module into queries;
conveying said queries to said at least one database;
generating response messages via said at least one database;
storing said response messages in a second storage area;
assigning to an agent calls which are not processed or which can not be processed by said voice input module; and
sending said response messages to respective sources, said response messages comprising one of text and audio format, said audio format created by conversion of a response message in said at least one voice output module.

2. The method according to claim 1, wherein response messages in audio format are supplemented with fixed speech texts.

3. The method according to claim 1 further comprising the step of storing in said second storage agent response messages created by agents in response to calls assigned to them.

4. The method according to claim 1 wherein said step of converting further comprises the step of determining correct syntax of said text messages before performing said step of converting text messages.

5. The method according to claim 4, further comprising the steps of assigning to an agent or storing in said first storage text messages which cannot be converted in said step of converting.

6. The method according to claim 5, further comprising the step of supplementing text messages stored in said first storage with comment text prior to said step of sending, said comment text dependent upon a result of said converting.

7. The method according to claim 1, further comprising the step of, prior to said step of sending, grouping said response messages in a text preprocessing unit included in said voice output module.

8. The method according to claim 1, further comprising the step of, prior to said step of sending, phonetically supplementing words in said response message when said words are in a foreign language.

9. The method according to claim 1, further comprising the step of, prior to said step of sending, prosodically supplementing words in said response message when said words are in a foreign language.

10. The method according to claim 1, wherein said step of converting further comprises the step of checking semantics and syntax of said incoming messages and incoming calls with a text output dispatcher included in said at least one voice input module, said step of checking being performed prior to said step of conveying.

11. The method according to claim 1, wherein said step of converting further comprises the step of suppressing noise or correcting deviations in audio levels of incoming messages in an acoustic preprocessing unit included in said voice input module.

12. The method according to claim 1, wherein said step of converting further comprises the step of providing a field in said standardized address which comprises time when a response message was sent in accordance with said step of sending.

13. The method according to claim 1, wherein said step of converting further comprises the steps:
directing inquires to an external database based upon information contained in incoming message inquiries, said directing being performed by way of an external interface; and
conveying inquiry response messages to said inquiries to said at least one database and storing said inquiry response messages therein.

14. The method according to claim 13, wherein said inquiries are conveyed to a plurality of external databases or information providers.

15. The method according to claim 13, wherein said step of converting further comprises the step of generating a service on a basis of at least one item of information contained in said stored incoming message, said service initiating said step of sending said response message.

16. The method according to claim 13, wherein said stored incoming message comprises a threshold which is conveyed for inquiry to said external database, and wherein said external database comprises at least one external database.

17. The method according to claim 16, wherein said response message is sent whenever a greater or smaller current value compared with said threshold value has been encountered.

18. A communication system for generating response messages, comprising:
at least one voice input module;
at least one voice output module;
a switchboard unit operable with messages, said messages comprising one of telephone calls and text messages;
at least one database assigned to said communication system;
terminals for agents;
means for storing messages in a first storage area, said messages being incoming by way of said switchboard unit;
means for switching said incoming messages to one of said at least one voice input module;
means for conveying inquiries generated by the voice input module to said at least one assigned database;
means for storing response messages generated by said at least one assigned database in text form and in a second storage area;
means for assigning messages unprocessed or incapable of processing by said at least one voice input unit to an agent; and
means for conveying a response message stored in the second storage area directly or by way of a response message converted in said at least one voice output module to a source of said incoming message.

19. The communication system according to claim 18, wherein said at least one voice output module comprises a text preprocessing unit, a speech synthesis unit and a voice output dispatcher.

20. The communication system according to claim 18, wherein said at least one voice input module comprises an acoustic preprocessing unit, a speech recognition unit and a text output dispatcher.

21. The communication system according claims 18, further comprising an interactive machine connected to said switchboard, said machine independently controlling interactive sessions.

22. The communication system according to claim 18, wherein said switchboard unit and/or said at least one voice input module and/or said a least one voice output module is distributed over a plurality of servers connected by way of a network.

23. The communication system according to claim 22, further comprising interfaces with the speech synthesis unit or with the speech recognition unit, said interfaces being designed such that on different servers different speech synthesis units or different speech recognition units can be exchanged with one another on said servers.

24. The communication system according to claim 23, further comprising a server on which a load distribution facility is implemented, said facility comprising means for assigning incoming calls and/or generated inquiries and/or response messages to different servers for processing.

25. The communication system according to claim 18, wherein said switchboard unit, said at least one voice input module, and said at least one voice output module are each implemented on a server connected to said system by way of a network.

26. The communication system according to claim 18, wherein said switchboard unit is attached by way of an external interface to a network either for connectionless use or for connection-oriented use.

27. The communication system according to claim 26, further comprising means for transferring data to said at least one database by way of said external interface.
